(19) United States
(12) Patent Application Publication
(10) Pub. No.: US 2011/0311283 A1
(43) Pub. Date: Dec. 22, 2011

(54) FIXING DEVICE AND IMAGE FORMING APPARATUS

(76) Inventor: Yoshihiro Fukuhata, Hyogo (JP)

(21) Appl. No.: 13/094,067

(22) Filed: Apr. 26, 2011

(30) Foreign Application Priority Data
Jun. 17, 2010 (JP) 2010-138280

(51) Int. Cl. G03G 15/20

(52) U.S. Cl. 399/327; 399/328

(57) ABSTRACT

A fixing device to fix a toner image on a recording medium, including a pressure roller to press the toner image on the recording medium; an elastically-deformable cylindrical fixing roller to contact the pressure roller to form a nip and transfer the recording medium to the nip to fix the toner image; and a holder to rotatably hold both ends of the fixing roller, wherein the holder is located at least two positions at both sides on an outer circumference of the fixing roller across the longest diameter thereof, and the nip is formed between the two holders at the side of the pressure roller.

### BACKGROUND OF THE INVENTION

1. Field of the Invention

The present invention relates to a fixing device used in an electrophotographic image forming apparatus such as a copier, printer, facsimile machine or a multifunctional apparatus having multiple such capabilities, and to an electrophotographic image forming apparatus incorporating the fixing device.

2. Description of the Related Art

As disclosed in Japanese Patent No. 3738615, in image forming apparatuses such as copiers and printers, a fixing device contacting a fixing roller and a pressure roller against each other to form a nip through which a recording medium bearing a toner image is transferred such that the toner image is fixed on the recording medium is conventionally known.

In the fixing device, as the fixing roller and the pressure roller, a hollow roller member including a metallic core and a thin elastic layer formed on the metallic core is commonly used so as to consume less heat and shorten a warm-up time. Further, the fixing roller typically includes a release layer as a surface layer besides the metallic core and the elastic layer.

For example, Japanese Patent No. 3738615 discloses a fixer using an elastic fixing roller having a thin and hollow structure.

However, with the conventional fixing device it is difficult to achieve a short warm-up time, good fixability, and long life in a simple form.

The warm-up time is a time for the fixing roller to have a surface temperature needed for a fixing process. Good fixability can be achieved when uniformity between a nip width in a transfer direction (nip amount) and a nip width in a rotational direction (perpendicular to the transfer direction) is sufficiently obtained. Long life can be achieved when there is no peeling of the elastic layer from the metallic core and no large deformations thereof.

Further, when the nip position shifts back and forth with rotation of the fixing roller, quality images without image noise cannot be produced. In Japanese Patent No. 3738615, both ends of the fixing roller are held by a bearing member having an inner diameter larger than an outside diameter of the fixing roller, and the fixing roller is sandwiched by the bearing member and the pressure roller to be driven. Therefore, when an SUS cylinder as the fixing roller rotates, the nip position occasionally shifts, resulting in generation of image noise.

For these reasons, a need exists for an uncomplicated fixing device capable of stabilizing a nip position in addition to having a short warm-up time, good fixability, and long life.

### SUMMARY OF THE INVENTION

Accordingly, an object of the present invention is to provide a fixing device capable of stabilizing a nip position in addition to satisfying all of short warm-up time, good fixability and long life in a simple form.

Another object of the present invention is to provide an image forming apparatus using the fixing device.

To achieve such objects, the present invention contemplates the provision of a fixing device to fix a toner image on a recording medium, comprising:

a pressure roller configured to press the toner image on the recording medium;

an elastically-deformable cylindrical fixing roller configured to contact the pressure roller to form a nip and transfer the recording medium to the nip to fix the toner image; and

a holder configured to rotatably hold both ends of the fixing roller,

wherein the holder is located at least two positions at both sides on an outer circumference of the fixing roller across the longest diameter thereof, and the nip is formed between the two holders at the side of the pressure roller.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic view illustrating an embodiment of the image forming apparatus of the present invention;

FIGS. 2A and 2B are schematic views illustrating an embodiment of the fixing device of the present invention;

FIG. 3 is a schematic view for explaining cleaning of the fixing device of the present invention; and

FIG. 4 is a schematic view illustrating another embodiment of the image forming apparatus of the present invention.

### DESCRIPTION OF THE PREFERRED EMBODIMENTS

Generally, the present invention provides a fixing device capable of stabilizing a nip position in addition to satisfying all of short warm-up time, good fixability and long life in a simple form.

More particularly, the present invention relates to a fixing device to fix a toner image on a recording medium, comprising:

a pressure roller configured to press the toner image on the recording medium;

an elastically-deformable cylindrical fixing roller configured to contact the pressure roller to form a nip and transfer the recording medium to the nip to fix the toner image; and

a holder configured to rotatably hold both ends of the fixing roller,

wherein the holder is located at least two positions at both sides on an outer circumference of the fixing roller across the longest diameter thereof, and the nip is formed between the two holders at the side of the pressure roller.

Namely, the metallic core of the roller member forming the nip is deformed and a deformation amount (AD) of an outer diameter of the metallic core in a transfer direction is maximized to satisfy all of short warm-up time, good fixability and long life in a simple form, and a location of the holder holding the roller member is maximized to stabilize the nip position. In the present invention, both sides of the roller member are rotatably held and loaded, and the roller member is distinguished from a belt or a sleeve evenly loaded in an axial (width) direction thereof.

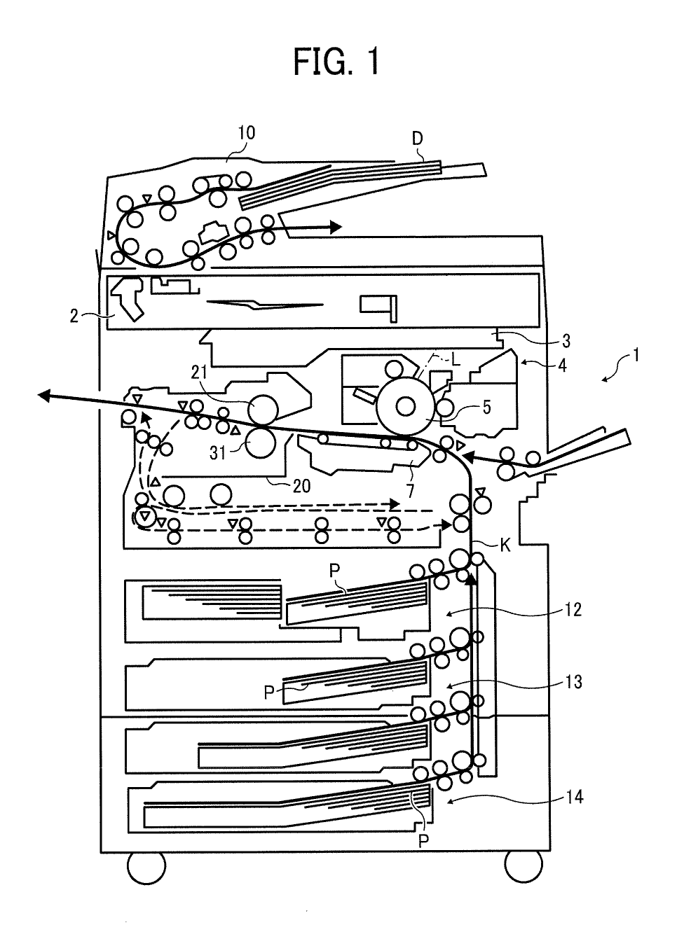

The configuration and operation of the whole image forming apparatus of the present invention will be explained, referring to FIG. 1.

An image forming apparatus 1 includes an original reader 2, an irradiator 3, an image former 4, a photoreceptor drum 5, a transferer 7, an original feeder 10, paper feeders 12, 13 and 14, and a fixing device 20.

In FIG. 1, the image forming apparatus 1 is a copier, the original reader 2 optically reads image information of an original D, the irradiator 3 irradiates the photoreceptor drum 5 with light L based on the image information read by the original reader 2, the image former 4 forms a toner image (image) on the photoreceptor drum 5, the transferer 7 transfers the toner image formed on the photoreceptor drum 5 onto a recording medium P, the original feeder 10 feeds the original D to the original reader 2, and the paper feeders 12, 13 and 14 contain the recording media P such as transfer papers.

The fixing device 30 includes a fixing roller 21 and a pressure roller 31. The fixing roller 21 is a roller member and the pressure roller 31 is another member.

Next, normal image forming operation of the image forming apparatus will be explained, referring to FIG. 1.

First, the original D is fed from an original table by a feed roller of the original feeder 10 in an arrow direction, and the original D passes the original reader 2 optically reading image information of the original D.

After the optical image information read by the original reader 2 is converted into an electrical signal, the electrical signal is transmitted to the irradiator 3 (writer). From the irradiator 3, light L such as a laser beam based on the image information of the electrical signal is irradiated to the photoreceptor drum 5 of the image former 4.

Meanwhile, the photoreceptor drum 5 in the image former 4 rotates in a clockwise direction, and an image (a toner image) is formed on the photoreceptor drum 5 after predetermined processes, i.e., a charging process, an irradiation process and a developing process.

Then, the image formed on the photoreceptor drum 5 is transferred by the transferer 7 onto the recording medium P fed by a registration roller.

The recording medium P fed to the transferer 7 runs as follows.

First, one of the plural paper feeders 12, 13 and 14 of the image forming apparatus 1 is automatically or manually selected. For example, the uppermost paper feeder 12 is selected.

The uppermost recording medium P in the paper feeder 12 is transferred toward a transfer route K.

Then, the recording medium P passes the transfer route K to the registration roller, and is transferred toward the transferer 7 in time for aligning with an image formed on the photoreceptor drum 5.

Then, the recording medium P reaches the fixing device 20 through the transfer route K after passing the transferer 7. Having reached the fixing device 20, the recording medium P is fed between the fixing roller 21 and the pressure roller 31, and the image is fixed with a heat from the fixing roller 21 and a pressure from both of the rollers 21 and 31.

After the recording medium P the image is fixed on is fed out between the fixing roller 21 and the pressure roller 31 (the nip), it is discharged from the image forming apparatus 1.

Thus, a series of image forming process is completed.

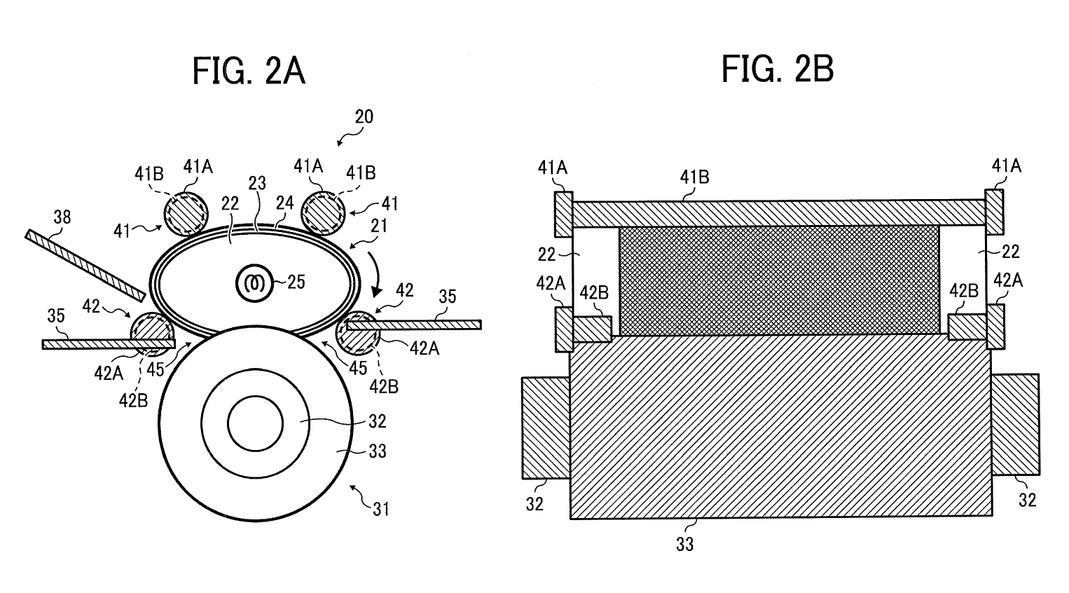

The configuration and operation of the fixing device 20 installed in the image forming apparatus 1 will be explained in detail. As FIG. 2 shows, the fixing device 20 includes the fixing roller 21, the pressure roller 31, a guide plate 35, a separation board 28, etc.

The fixing roller 21 as a roller member is a thin cylinder rotating in an arrow direction in FIG. 2, and a heater 25 (heat source) is located in the cylinder. The fixing roller 21 has a multilayered structure including a metallic core 22, an elastic layer 23 and a release layer in this order, and contacts the pressure roller 31 to form a nip 45. The metallic core 22 of the fixing roller 21 is made of an iron material such as SUS304 having a Young's modulus of from 1.5×10¹¹ to 2.7×10¹¹ Pa. In addition, the metallic core preferably has a thickness of from 50 to 300 μm because of being used in an elastic state with a load. In this embodiment, the metallic core has a thickness of 120 μm.

Known elastic materials such as fluorine-containing rubbers, silicone rubbers and foamed silicone rubbers are preferably used as the elastic layer 23 of the fixing roller 21. Particularly, when the silicone rubber is used as the elastic layer 23, a fluorine-containing layer is preferably formed on thereon to improve anti-swellability.

The elastic layer 23 preferably has a thickness not greater than 2 mm. This can shorten the warm-up time of the apparatus. In this embodiment, the elastic layer 23 has a thickness of 0.5

MM.

The elastic layer 23 preferably has a rubber hardness (JIS-A) not greater than 8 Hs. This enables the nip 45 to have a sufficient nip width and good fixability. In this embodiment, the elastic layer 23 has a rubber hardness (JIS-A) of 8 Hs.

Further, the elastic layer 23 preferably has a permanent deformation not greater than 4%. This can prevent shorter life of the fixing roller 21 (elastic layer 23). In this embodiment, the elastic layer 23 has a permanent deformation of 4%.

Known resins applicable to the fixing roller such as PFA (tetrafluoroethylene-perfluoroalkylvinylether copolymer resins), polyimide, polyetherimide and PES (polyethersulfide) can be used as the release layer 24 of the fixing roller 21. The release layer 24 as a surface layer of the fixing roller 21 assures releasability (separability) of a toner T (toner image). In this embodiment, the release layer 24 is a PFA tube having a thickness of 0.03 mm.

The heater 25 in the fixing roller 21 is a rod-shaped heater including an electrically-heated wire, and both ends thereof are fixed on a side board of the fixing device 20. The heater 25 controlled by a power source of the apparatus 1 heats the fixing roller 21 and a heat is applied to the toner image T on the recording medium P from the surface of the fixing roller 21. The heater 25 is controlled, based on detection results of the surface temperature of the fixing roller 21 by a thermistor (not shown). The thus controlled heater 25 can make the fixing roller 21 have a desired (fixing) temperature.

Next, the pressure roller 31 is mainly constituted of a metallic core 32 and an elastic layer 33 formed on an outer circumference thereof through an adhesive layer. The elastic layer 33 of the pressure roller 31 is formed of known materials such as fluorine-containing rubbers, silicone rubbers and foamed silicone rubbers. A thin release layer formed of PFA or the like may be formed on the surface of the elastic layer 33.

The pressure roller 31 is pressed to the fixing roller 21 by an unillustrated pressurizer. Thus, the desired nip 45 is formed between the pressure roller 31 and the fixing roller 21. In this embodiment, a load of 200 N is applied to the fixing roller 21.

A guide plate 35 is located at the entrance and the exit, respectively, of the contact point (nip 45) between the pressure roller 31 and the fixing roller 21. The guide plate 35 is fixed on a side board of the fixing device 20.

At the exit of the nip 45 facing an outer circumference of the fixing roller 21, a separation board 38 is located. The separation board 38 prevents the recording medium P from winding the fixing roller 21 along with the rotation thereof after the fixing process.

When an image is fixed, the pressure roller 31 is driven to rotate the fixing roller 21. In this embodiment, both ends of the fixing roller in an axial direction thereof are held as they typically are. However, since the fixing roller 21 bends itself, they are held as follows not only by a typical ball bearing or a slide bearing.

The holder of the fixing roller 21 will be explained, referring to FIG. 2. FIG. 2A is a cross-sectional view of the fixing device 20 and FIG. 2B is a view seen from left.

In FIG. 2A, the fixing roller 21 is located above and the pressure roller 31 is located below. At least two holders 41 are located on the outer circumference of the upper half of the fixing roller 21, and a holder 42 is located before and after the nip 45, respectively, on the outer circumference of the lower half thereof. Namely, at least the total four holders 41 and 42 hold the fixing roller 21.

Since a pressure load is applied between the fixing roller 21 and the pressure roller 31, the fixing roller 21 is held at least at five positions by the four holders 41 and 42 and the pressure roller 31. The four holders 41 and 42 are rotatable and driven to rotate with the fixing roller 21. When the holders 41 and 42 are not rotated, the frictions among the holders 41 and 42, and the fixing roller 21 cause uneven rotation thereof, resulting in image noises.

The reason why the four holders 41 and 42 are arranged will be explained. The two holders 41 located on the outer circumference of the upper half of the fixing roller 21 hold the fixing roller 21 pressed by the pressure roller 31 from the above.

When the fixing roller 21 is only held at the three positions by the two holders 41 located on the outer circumference of the upper half of the fixing roller 21 and the pressure roller 31, and driven, uneven thickness and/or cylindricity of the metallic core 22 of the fixing roller 21 shifts the nip 45 upstream or downstream in a rotational direction of the fixing roller 21, resulting in image noises.

Therefore, the holders 42 are located upstream or downstream from the nip 45 to prevent the nip 45 from shifting upstream or downstream. Namely, the fixing roller 21 held at least at five positions by the four holders 41 and 42 and the pressure roller 31 can form a nip 45 without image noises.

Next, the fixing roller 21 can be held in an axial direction thereof with the outer forms of the rotating holders 41 and 42. Specifically, as FIG. 2B shows, the holders 41 and 42 have smaller outer diameter parts 41B and 42B and larger outer diameter parts 41A and 42A. The smaller outer diameter parts 41B and 42B receive a load in a rotational direction of the fixing roller 21 and a level difference between the smaller outer diameter parts and the larger outer diameter parts regulate in an axial direction of the fixing roller 21. The holders 41 and 42 at both ends have at least one such level difference, respectively. It is preferable that a distance between the level differences at both ends is slightly longer than a width of the fixing roller 21. This is because the fixing roller 21 swells by a few % when heated, and the distance is preferably longer than the width of the fixing roller 21 by 0.5 to 2 mm.

In this embodiment, the holders 41 are located at the both ends and expand into even a printing area, contacting the release layer 24 therein. Specifically, the holders 41 hold the fixing roller from one end to the other end. The outer diameter of the holder at the part facing the part coated with an elastic material of the fixing roller is smaller than that thereof at the part facing the uncoated par of the fixing roller. The surface layer of the holder is made of the same material as that of the release layer 24 or a cloth so as not to damage the surface layer of the fixing roller 21.

The cylindrical metallic core of the roller member forming the nip 45 is deformed and the deformation amount thereof in a transfer direction is maximized to satisfy all of the short warm-up time, good fixability and long life.

The holders 42 are located upstream or downstream from the nip 45 to prevent the nip 45 from shifting upstream or downstream. Namely, the fixing roller 21 held at least at five positions by the four holders 41 and 42 and the pressure roller 31 can form a stable nip 45 to produce quality images without image noises.

The fixing roller 21 is held in an axial direction thereof with the outer forms of the rotating holders 41 and 42 having smaller outer diameter parts 41B and 42B and larger outer diameter parts 41A and 42A. The smaller outer diameter parts 41B and 42B receive a load in a rotational direction of the fixing roller 21 and a level difference between the smaller outer diameter parts and the larger outer diameter parts regulate in an axial direction of the fixing roller 21, which can stabilize the nip position to produce quality images without image noises.

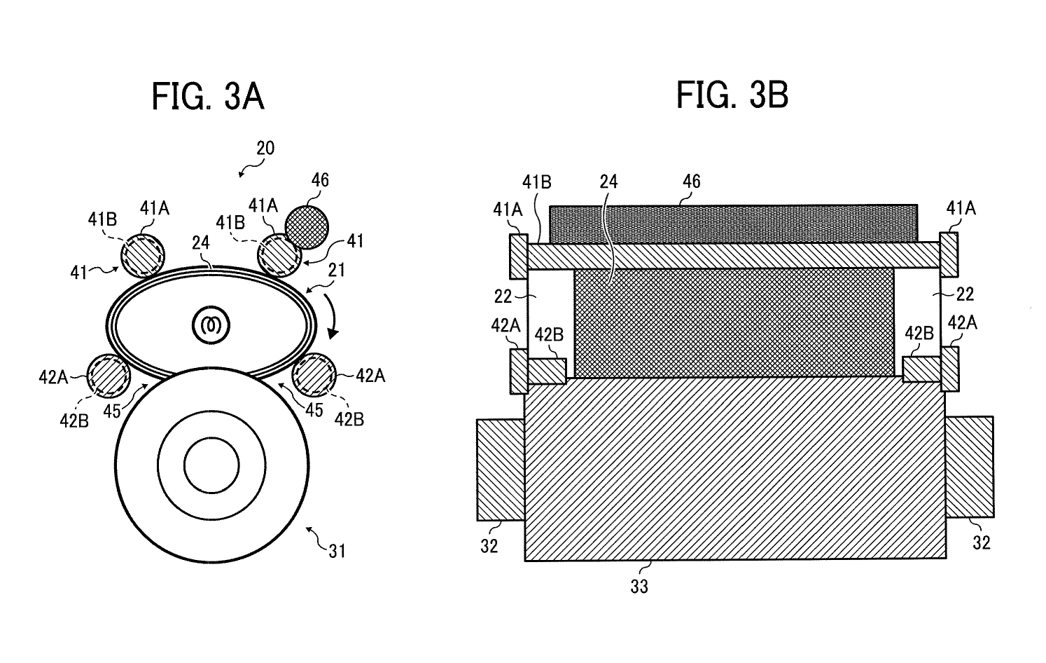

FIG. 3 is a schematic view for explaining cleaning of the holder 41 holding the fixing roller 21 of the fixing device 20 explained in FIG. 2. Since the holder 41 contacts the fixing roller 21 and rotates therewith, an unfixed toner remaining on the surface layer of the fixing roller 21 adheres to the holder. Therefore, a cleaning roller 46 (may be a cleaning blade) in FIG. 3 cleans the holder 41. The cleaning roller 46 has a configuration applicable, which is not limited by the embodiment in FIG. 2.

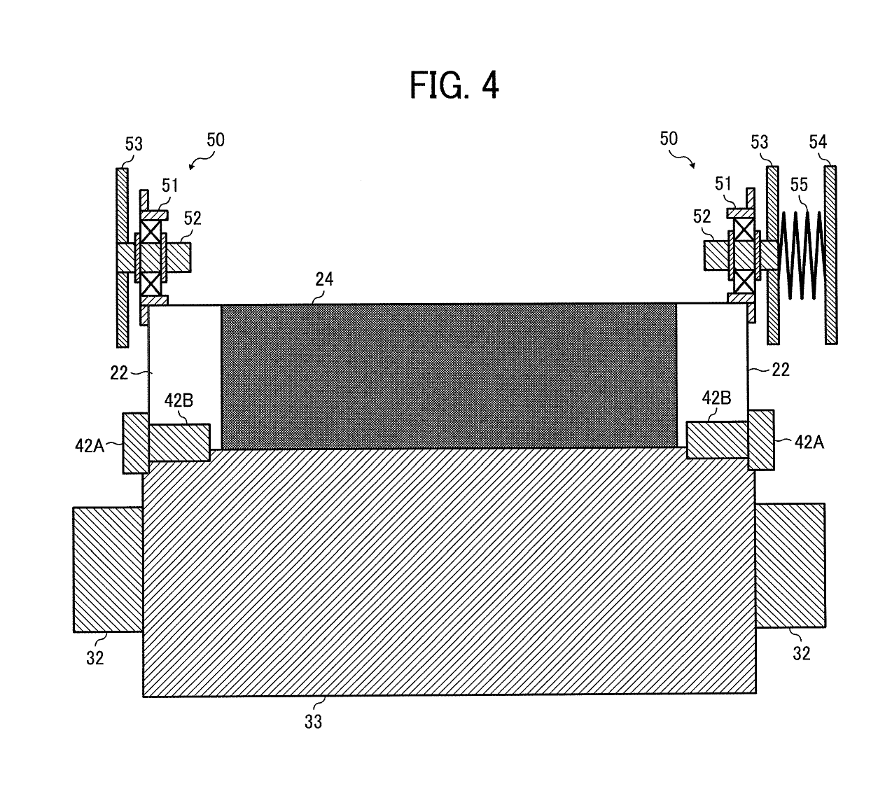

Another embodiment of the holder of the fixing roller 21 will be explained, referring to FIG. 4. FIG. 4 is a schematic view illustrating the fixing device seen from left as FIG. 2B.

A holder 50 on the left in FIG. 4 includes a rotational axis 52 at a fixed part 53 and a holding roller 51 having a level difference rotatable around the rotational axis 52. The level difference fixes an axial direction of the fixing roller 21. A holder 50 on the right includes the same. An elastic material 55 between the fixed part 53 and a fixed part 54 has a biasing force in an arrow direction, and the holders 50 sandwich the fixing roller 21 while pressing the roller.

In this embodiment, when a holder having a level difference is fixed on an end and a holder having a level difference at the other end is biased by an elastic material toward the opposite holder, the fixing roller 21 can be regulated in an axial direction thereof and the fixing nip 45 does not shift back and forth in a transfer direction to produce quality images without image noises.

The present invention has been explained, exemplifying fixing devices using heat roller methods, but is not limited thereto. Fixing devices using electromagnetic induction heating methods can also be used, which have the same effect of this embodiment.

In this embodiment, an elastically-deformable cylinder is uses as the fixing roller, and can be used as the pressure roller.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Application No. 2010-138280 filed on Jun. 17, 2010, the entire contents of which are herein incorporated by reference.

What is claimed is:

1. A fixing device to fix a toner image on a recording medium, comprising:
a pressure roller configured to press the toner image onto the recording medium;
an elastically deformable cylindrical fixing roller disposed opposite the pressure roller and configured to contact the pressure roller to form a nip and transport the recording medium to the nip to fix the toner image thereon; and
a holder configured to rotatably hold both ends of the fixing roller,
wherein the holder is located at at least two positions on both sides along an outer circumference of the fixing roller across the longest diameter thereof, and the nip is formed between the two holders at the pressure roller side.

2. The fixing device of claim 1, wherein the holder is rotatable.

3. The fixing device of claim 1, wherein at least one of the holders has a continuous body from one end to the other end and contacts the fixing roller in an area through which the recording medium passes.

4. The fixing device of claim 1, wherein a part of the holder contacting the fixing roller is formed of a cloth or a tetrafluoroethylene-perfluoroalkylvinylether copolymer resins (PFA).

5. fixing device of claim 4, wherein the cloth functions as a cleaner.

6. The fixing device of claim 1, wherein a part of the holder which does not contact the fixing roller has a diameter larger than that of the part thereof contacting the fixing roller.

7. The fixing device of claim 1, wherein a level difference between the part of the holder of enlarged diameter which does not contact the fixing roller and the part thereof of reduced diameter contacting the fixing roller restricts both ends of the fixing roller in an axial direction thereof.

8. The fixing device of claim 1, wherein a distance between the level differences of the two ends is longer than a width of the fixing roller.

9. The fixing device of claim 1, wherein the holder at a first side is fixed and the holder at a second side opposite the first side is biased by an elastic material toward the fixed holder to restrict both ends of the fixing roller in an axial direction thereof.

10. An image forming apparatus, comprising:
a photoreceptor configured to bear an image;
an irradiator configured to irradiate the photoreceptor to form an electrostatic latent image thereon;
an image former configured to develop the electrostatic latent image with a toner to form a toner image;
a transferer configured to transfer the toner image onto a recording medium; and
the fixing device configured to fix the toner image on the recording medium according to claim 1.
